(19) United States
(12) Patent Application Publication
(10) Pub. No.: US 2004/0037264 A1
(43) Pub. Date: Feb. 26, 2004

(54) Pre-negotiated quality of service

(76) Inventor: Charbel Khawand, Miami, FL (US)

Correspondence Address: Scott M. Garrett, Motorola, Inc., Law Department, 8000 West Sunrise Boulevard, Fort Lauderdale, FL, 33322, US

(21) Appl. No.: 10/227,117

(22) Filed: Aug. 23, 2002

(51) Int. Cl. H04J 3/24

(52) U.S. Cl. 370/349; 370/329

(57) ABSTRACT

The invention relates to a system and method for use in wireless packet data mode communications, for enabling faster connection time for communications between a mobile station (102) and a base station (106). The invention provides for the use of a profile identifier to reference and activate on a base station (106) a quality of service related to the communication between the mobile station (102) and the base station (106). The profile identifier (506) is uniquely associated with a quality of service profile (508), which was pre-negotiated by the mobile station (102) or is a quality of service profile (508), which is permanent for the type of mobile station (102).

### FIELD OF THE INVENTION

The invention relates to wireless system communications. More particularly, the invention relates to the reduction in setup and configuration time for remote wireless units by retrievably storing, accessing and utilizing pre-negotiated or permanent quality of service profiles.

### BACKGROUND OF THE INVENTION

The wireless industry has grown at a tremendous pace over the past few years. Wireless communication has become a standard part of every day life. Most people utilize some variant form of wireless communications such as Global System for Mobile communication (GSM), Universal Mobile Telecommunications System (UMTS), Carrier Detection Multiple Access (CDMA) and 802.11 in various aspects of daily living.

Generally, radio systems are designed for a certain area of coverage or footprint. These areas are generally referred to as cells. Cells enable the reuse of similar frequencies by multiple sources to support services in metropolitan areas that are some distance apart. The geographic size of cells are not necessarily consistent throughout a given area and may vary due to frequency and power level, topography of the area, time of day and so forth. Communications within these cells take advantage of a concept known as Demand Assigned Multiple Access (DAMA). DAMA enables multiple devices to access a network in a shared manner on a demand basis. Basically, devices access the network on a first come, first serve basis. Within a wireless network, there are a number of ways in which multiple access can be provided to end-users. At the most basic level, there is a Frequency Division Multiple Access (FDMA) methodology, which is essentially the starting point for all wireless communications, given that each cell must be separated by frequencies to avoid interferences among wireless devices. FDMA divides assigned frequency ranges into multiple carrier frequencies in order to support multiple conversations.

Another method that is utilized in wireless networking is the Time Division Multiple Access (TDMA), which is a digital technique that divides each frequency channel into multiple time slots. Each of the time slots within a frequency channel supports an individual device conversation. Generally speaking, services based on TDMA offer roughly three times the traffic capacity of FDMA services.

Yet another communication methodology which is relatively new and has its root in spread spectrum radio is known as Code Division Multiple Access (CDMA). Spread spectrum radio spreads the bandwidth of a transmitted signal over a spectrum of radio frequencies. The combined spectrum of radio frequencies is usually much wider than what is required to support the narrow band transmission of the signal. Spread spectrum uses two techniques namely, Direct Sequence (DS) and Frequency Hopping (FH). In brief, direct sequence spread spectrum is a packet radio technique in which the narrow band signal is spread across a wider carrier frequency band. In other words, the signal information is organized into packets, each of which is transmitted across a wider carrier band frequency in a redundant manner i.e. packets are sent more than once. Multiple transmissions can then be supported. The transmissions from specific terminals are identified by a unique code such as, a 10 bit code that is pre-pended to each data packet. Frequency Hopping Spread Spectrum is generally preferred over direct sequence spread spectrum. FHSS involves transmission of short bursts of packets within the wide band carrier over a range of frequencies. Essentially, the transmitter and receiver hop from one frequency to another in a choreographed hop sequence and a number of packets are sent to each frequency. The hop sequence is controlled by a centralized base station antennae.

Regardless of the communication methodology for a given network, a certain amount of pre-configured set-up and real time set-up of communication devices will be required. One such requirement for communication between a remote/mobile unit and a base station is the set-up and configuration of certain communication parameters such as Quality of Service (QoS). For example, with packet data mode communications data rate, availability and maximum delay time for each packet communication must be set-up and negotiated between the remote unit and the base. Generally, this negotiation and configuration occurs in real time at the moment when the remote unit first initiates a communication session with the base station. In particular, packet mode capable user equipment are able to negotiate their QoS prior to connecting to the network infrastructure. The negotiation typically includes the selection of a certain QoS for the communication between the network and the user equipment, as requested by the user equipment. The request is obtained by a base station, which then attempts to appropriate and allocate the required resources. This process conceivably involves time delays and repeated communication exchange between the user equipment and the base. Furthermore, this negotiation occurs on a standard signaling channel thus tying-up network system resources-bandwidth, channel allocation and time.

The nature of QoS, particularly for standard services is such that there is a repetition of similar requests to the network system from multiple user equipment. For example, a particular WCDMA UMTS capable user equipment connects to the internet with a QoS set to ‘background’ and a date rate of 56K. The reality is that all user equipment of similar type will also operate at the same QoS, thus resulting in multiple requests and negotiations on the network.

In light of the above discussion, there exists a need for a system and method to enable negotiations at non-connection times, provide a mechanism for storing previously negotiated information and a method for retrieving that information when communication needs to occur between the remote user equipment and the network system. Furthermore, there exists a need to reduce network delay and undue extended utilization of network system resources for repetitive negotiations.

### BRIEF SUMMARY OF THE INVENTION

The invention relates to a system and method for use in wireless packet data mode communications, for enabling faster connection time for communications between a mobile station and a base station. The invention is directed to the generation of a profile for a quality of service related to the communication between the mobile station and the base station. It further includes associating a profile identifier with the quality of service and utilizing the profile identifier to reference and activate a needed quality of service profile on the base station, for use by the mobile station.

### BRIEF DESCRIPTION OF THE DRAWINGS

FIG. 1 is a block diagram of an exemplary wireless communication system in which the invention can be practiced.

FIG. 2 is an electrical blocked diagram of an exemplary remote unit in accordance with the invention.

FIG. 3 is a block diagram of the service level communications on a typical wireless network.

FIG. 4A is an illustration of typical broadcast scenario involving a pre-negotiated quality of service profile between a base station and a remote user equipment.

FIG. 4B is an illustration of typical broadcast scenario involving a permanent quality of service profile between a base station and a remote user equipment.

FIG. 5 is a diagram representing a database that could be utilized for accessing and storing profiles utilizing international mobile subscriber identity.

### DETAILED DESCRIPTION OF THE INVENTION

The invention provides a unique system and method for setting up and establishing communication between remote units and a base station. The invention is applicable in wireless communication devices that utilize packet data modes for paging or chatting.

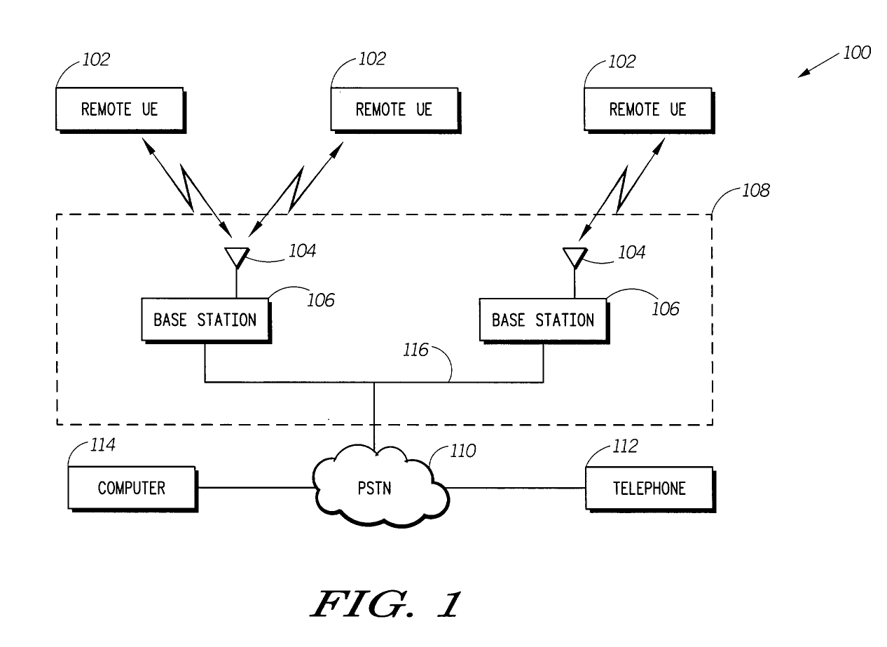

Referring initially to FIG. 1, a blocked diagram illustrates a wireless communication system, environment in which the invention can be practiced. As shown, a fixed portion 108 includes one or more base stations 106, which provide communication to a plurality of remote user equipment 102. The base stations 106 coupled by communication link 116 preferably communicates with the user equipment 102 utilizing conventional radio frequency techniques. One or more antennae 104 provide communication from the base stations 106 to the remote user equipment 102. The base stations 106 preferably also receive RF signals from the plurality of remote user equipment units 102 via antennae 104. In an embodiment of the invention messages communicated between base station 106 and remote user equipment 102 comprise a selective addressing scheme to identify the initiating or target device. Information exchanged between base station 106 and remote user equipment 102 can include data messages, commands and adjustments to operating parameters for the communication system. Also transmitted between remote user equipment 102 and base stations 106 are responses to scheduled messages, positive Acknowledgments (ACKS), Negative Acknowledgments (NAKS), and unscheduled messages such as registration requests and requests for items of information. It will be appreciated by those skilled in the art that other methods and schemes for wireless communication may be utilized to communicate between the base station 106 and the remote user equipment 102, or between multiple remote user equipment 102. Such methods are contemplated by and are within the scope of the invention.

The fixed portion 108 of the communications network 100 is coupled to a Public Switch Telephone Network (PSTN) 110 for receiving and sending messages to other device types like telephone 112 and computer 114. Calls or information initiated by or destined for a remote user equipment 102 can be received by or originated from a device such as telephone 112 or computer 114. Those skilled in the art recognize that alternate types of networks, for example, Local Area Networks (LAN), Wide Area Networks (WAN) and the Internet, can be used for receiving or sending selective call information to the wireless network 100. A computer such as computer 114 can also serve as a central repository for various applications and information utilized by the wireless communication system.

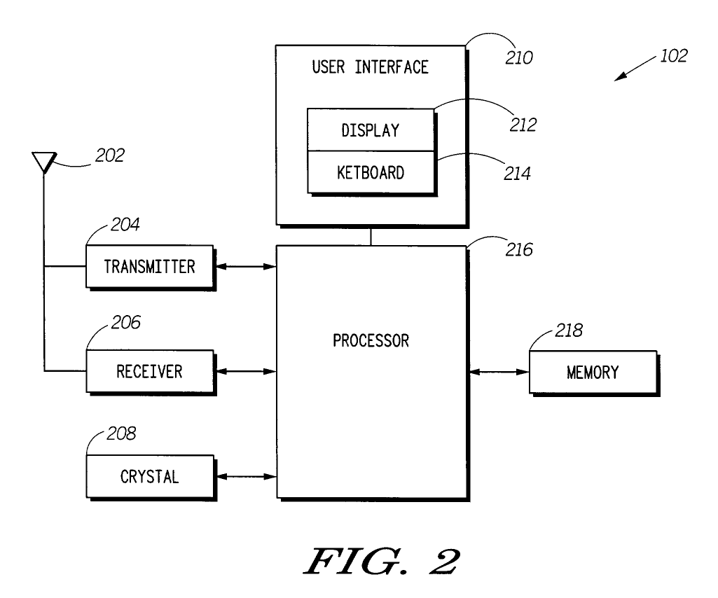

It will be further appreciated that the invention is applicable to other types of wireless communication systems including dispatch systems, cellular telephone systems and voice and/or data messaging systems. A remote communication unit that can be utilized in the invention will be discussed with reference to FIG. 2.

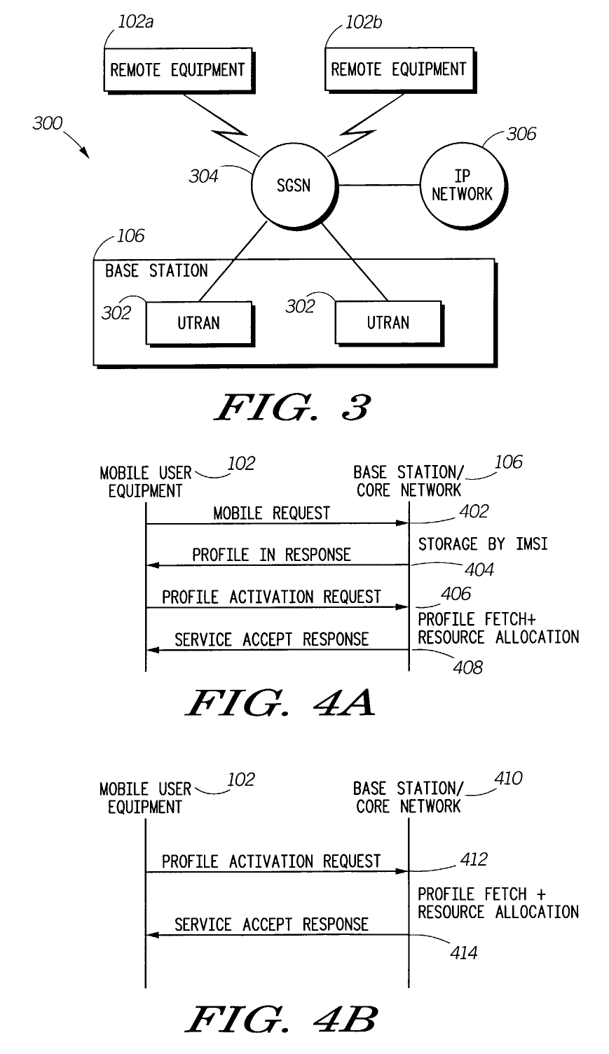

FIG. 2 illustrates an exemplary remote user equipment 102 and its various components. The remote user equipment 102 comprises an antennae 202 that is utilized for receiving inbound messages and for transmitting outbound messages. The antennae 202 is coupled to a transmitter 204 and a receiver 206. Both the transmitter 204 and the receiver 206 are coupled to a processor 216 for processing information relating to outbound and inbound messages and for controlling the remote user equipment 102 in accordance with the invention. A user interface 210 is operably coupled to the processor 216 for providing user interaction and feedback. In an embodiment of the invention, the user interface 210 comprises a display 212 and a keyboard 214. The display 212 provides a user with operative information and feedback from the processor 216. The keyboard 214 enables a user to provide input or response to the processor 216. Other methods and systems for user interaction and feedback could also be used to accomplish the objects of the invention. A crystal oscillator 208, provides conventional timing to the processor 216 and other components of the remote user equipment 102. Processing is performed by the processor 216 in conjunction with memory 218. The memory 218 comprises software instruction and data for programming and operating the remote user equipment 102 in accordance with the invention. Remote user equipment 102 operates to communicate to a base station 106. Such operation will be discussed in detail with reference to FIG. 3, 4A, 4B and 5.

For purposes of illustration, explanation and not limitation, the invention will be discussed with reference to the UMTS environment. The invention is equally applicable and capable to be utilized in any wireless communication strategy or methodology.

A brief overview of the UMTS environment will be discussed with reference to FIG. 3. As shown in FIG. 3, a base station 106 comprises one or more UMTS Terrestrial Radio Access Network (UTRAN) components 302. As previously mentioned, UMTS is a packet mode communication scheme. As such, there exists a General Packet Radio Service (GPRS) that provides the environment for communication between remote user equipment 102 and base station 106. GPRS provides packet routing and gateway services through a Serving GPRS Support Node (SGSN) 304. SGSN is positioned to communicate between remote user equipment 102 and UTRAN 302 of a base station 106. SGSN 304 also provides connection and communication to an IP network 306.

In operation, a remote user equipment 102 negotiates with SGSN 304 for the Quality of Service (QoS) that will be utilized in the communication with UTRAN 302 of the base station 106. QoS includes such things as data rate for communications, availability, maximum time delay for packet communications and so on. The quality of service negotiation involves multiple bi-directional communications between remote user equipment 102 and base station 106 devices. The nature of these device communications and the types of messages that are exchanged will be discussed further with reference to FIGS. 4A and 4B.

While this discussion will ensue with reference to a UMTS system, it should be understood that it is for the purpose of illustration rather than limitation. The system and method of the invention is applicable to other packet data capable networks and workstations. In the particular instant of UMTS as previously stated, the user equipment negotiates with the SGSN the required QoS for its upcoming service. Because this request is time consuming and potentially repetitive, the system and method of the invention enables a user equipment to send a Profile Identification (Profile ID) to the system rather than a QoS request. The Profile ID is used by the system to identify, fetch or locate within a database, a pre-negotiated or permanent QoS for the particular user equipment. In other words, the network system is able to activate a stored QoS for packet data based on a Profile ID. A Profile ID is created as a result of the negotiation procedure between the user equipment and the base station of the network system. In particular, and as previously discussed, the mobile user equipment negotiates QoS with SGSN. SGSN creates a Profile ID for the resulting QoS and communicates the Profile ID to the user equipment. In turn, when the user equipment contacts SGSN at a later point in time, a can merely provide the Profile ID to obtain the stored QoS rather than negotiate a new QoS. QoS profiles can be either pre-negotiated for those items and parameters that vary or be permanent for particular types of parameters such as, data rates for similar user equipment types. An exemplary method for implementing each case will be discussed with reference to FIGS. 4A and 4B respectively.

FIG. 4A illustrates a typical broadcast scenario involving a pre-negotiated quality of service profile between a base station and a remote user equipment. As shown, there is a mobile station 102 which represents the user equipment and a core network 106 which represents the base station. In an embodiment of the invention, the mobile station 102 can negotiate a particular quality of service with the core network 106 either during an initial communication sequence or during an idle period. In either case, the mobile station 102 requests a packet data context from the core network 106, at step 402. In response to the request, the core network 106 stores a negotiated mobile system 102 profile otherwise referred to as a packet data profile in its database. This profile is bound to the mobile station's 102 International Mobile Subscriber Identity (IMSI). IMSI uniquely identifies an individual mobile station 102. The packet data profile of the mobile station 102 is stored in the database of the core network 106 and identified by the IMSI. The stored information remains in the database as long as the mobile station 102 remains authenticated. Furthermore, the Profile ID identified by the equipment IMSI is returned to the mobile station 102. This Profile ID is then stored by the mobile station 102 and utilized whenever there is a need to communicate with the core network 106. In particular, the mobile station 102 requests an activation of a particular profile by passing a Profile ID to the core network 106 at step 404. In response to this request, the core network 106 fetches the requested profile and allocates resources as available at step 406. Following this, the core network sends a service accept to the mobile station 102, at step 408. Thus enabling the use of the quality of service profile that was previously negotiated by the mobile station 102, without a time delay or resource utilization associated with negotiating QoS.

In FIG. 4B the case of the permanently stored quality of service profile is illustrated. In the case of permanently stored quality of service profile, the system is aware of some standard services in which parameter values are essentially constant. Such a service can be a ‘dispatch’ operation in iDEN mobile phone systems. Within such a system, the data rate and the QoS do not vary between different user equipment and therefore do not need to be renegotiated. Thus, when a mobile station 102 decides to activate a dispatch service, it essentially sends a Profile ID to the core network 106 in order to obtain the permanent profile that it requires to enable its resources.

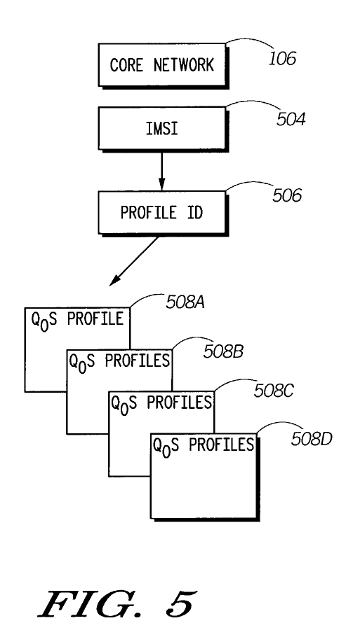

In an embodiment of the invention as shown in FIG. 4B, a core network has a pre-stored QoS profile. The Profile ID that is associated with this QoS can either be broadcasted when created or sent to mobile stations 102 when requested. In either case, when a mobile station 102 requests an activation of a particular profile at step 412 it is able to pass the received Profile ID, which is associated with the pre-stored QoS. In response to the request, the core network including a base station 106 fetches the requested profile and allocates resources as available. The core network including a base station 106 further sends a service accept to the mobile station 102 at step 414. Having described how the profile is created and how it can be utilized the next topic of discussion is to the storage of the QoS profile. The QoS profile is stored in a database, which will be discussed with reference to FIG. 5.

As previously discussed, the core network 106 stores by IMSI 504 a particular Profile ID 506, which points to one of several QoS profiles 508A-508D. In operation, when the core network 106 receives a request from a mobile station 102 the system and method of the invention is able to authenticate and verify the user equipment by looking at the IMSI record 504 along with the particular Profile ID 506 that was received from the mobile station 102. This information is then used to obtain either a permanently stored QoS profile 508A-508D or a previously negotiated QoS profile 508A-508D from the database. The appropriate QoS profile is then activated for use in communication between the mobile station 102 and the core network 106.

In an embodiment of the invention, UTRANS are able to pass Profile ID's and related QoS information between themselves during ‘hand-over’—i.e. the passing of the user equipment from one cell to another. Also in an embodiment of the invention, a Profile ID can be updated through a re-negotiation by a particular user equipment. In a further embodiment, one SGSN could update another SGSN as the user equipment travels between areas covered by a different SGSN. In the event that a user equipment encounters an SGSN that does not support Profile ID's, the system and method of the invention allows the user equipment to revert to the standard technique of negotiating quality of service.

The invention has been described in relation to particular embodiments which are intended in all respects to be illustrative rather than restrictive. Alternative embodiments will become apparent to those skilled in the art to which the invention pertains without departing from its scope. The invention facilitates the reduced utilization of communication channel capacity, minimizes power consumption on a remote user equipment and decreases the amount of time involved in setting-up communications.

From the foregoing, it will be seen that this invention is one well adapted to obtain all of the ends and objects set forth above, together with other advantages which are obvious and inherent to the system and method. It will be understood that certain features and sub-combinations are of utility and may be employed without reference to other features and sub-combinations. This is contemplated by and is within the scope of the claims.

We claim:

1. A method for use in wireless packet data mode communications for establishing faster connection time for communicating between a mobile station and a base station, comprising:
generating a profile of a quality of service for the communication between the mobile station and the base station;
associating a profile identifier with said quality of service profile;
utilizing said profile identifier on said mobile station, for referencing said quality of service profile; and
activating on said base station, said quality of service profile upon receipt of a request from said mobile station that specifies said profile identifier.

2. The method of claim 1, wherein said quality of service is pre negotiated between the mobile station and the base station.

3. The method of claim 1, wherein said quality of service is permanent for the service on the mobile station.

4. The method of claim 1, further comprising storing said profile identifier and profile on said base station.

5. A method for use in wireless communications for obtaining a quality of service for a remote user equipment, comprising:
receiving a profile identifier for the quality of service;
utilizing said profile identifier to cause a base station to activate said quality of service on said base station; and
communicating between the remote user equipment and said base station utilizing said quality of service.

6. The method of claim 5, wherein said quality of service is pre-negotiated between the remote user equipment and said base station.

7. The method of claim 5, wherein said quality of service is a permanent quality of service for a service type performed on the remote user equipment.

8. An apparatus for use in communicating from a remote location comprising:
a memory; and
a computing component;
wherein said apparatus requires a quality of service to communicate with a base station;
wherein said computing component is adapted to receive a profile identifier that is associated with the quality of service, utilizing said profile identifier to cause the base station to activate the associated quality of service on said base station; and communicate to the base station utilizing said quality of service.

9. A method for use in wireless communications for obtaining a quality of service for communicating with a remote user equipment, on a base station, comprising:
generating a profile identifier that is associated with a quality of service;
sending said profile identifier to the remote user equipment;
receiving said profile identifier from the remote user equipment; and
activating on said base station, said quality of service associated with said profile identifier, for use in communication with the remote user equipment.

10. An apparatus for producing a signal representing data in a wireless packet data mode communication environment for utilizing a quality of service in communicating to a remote user equipment comprising:
a profile identification component;
a transceiver component; and
a service activation component;
said profile identification component provides a profile identifier that is associated with a quality of service;
said transceiver component adapted to send said profile identifier to the remote user equipment and receive said profile identifier from the remote user equipment for use by said service activation component to enable the quality of service for communicating to the remote user equipment.

11. A system for use in wireless packet data mode communications comprising:
a base station;
a quality of service profile; and
a profile identifier;
said profile identifier utilized to invoke said quality of service profile on said base station for use in the communication between said base station and a remote user equipment.
